(19) United States
(12) Patent Application Publication
(10) Pub. No.: US 2011/0184808 A1
(43) Pub. Date: Jul. 28, 2011

(54) TARGETED CONTENT IN PRINT MEDIA

(75) Inventor: MEHUL SANGHAVI, Sunnyvale, CA (US)

(73) Assignee: Yahoo! Inc., Sunnyvale, CA (US)

(21) Appl. No.: 12/693,658

(22) Filed: Jan. 26, 2010

(51) Int. Cl. G06Q 50/00; G06F 15/00; G06Q 30/00

(52) U.S. Cl. 705/14.64; 358/1.15; 705/14.66

(57) ABSTRACT

A device for retrieving targeted content associated with a print medium that includes a transceiver that receives identification data indicative of a user of the print medium where the transceiver transmits the identification data to a content server and an output module that provides targeted content received from the content server to a user of the device, where the target content is based on the identification data indicative of the user.

### BACKGROUND

1. Technical Field

The present disclosure relates generally to content retrieval systems and methods and, more particularly, to targeted content retrieval and delivery associated with print media.

2. Related Art

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Currently, content such as advertising delivered through computer networks such as the Internet is widely used along with advertising delivered through other mediums, such as television, radio, and print. Online advertising, for example, distributed through the Internet provides a mechanism for merchants to offer advertisements for a vast amount of products and services to online users. In terms of marketing strategy, different online advertisements have different objectives depending on the user toward whom an advertisement is targeted. This flexibility of being able to provide different online advertisements enables advertisers to target specific users thereby providing a more personalized advertisement experience.

However, advertising distributed through various print media (e.g., magazines, journals, newspapers, flyers, etc.) generally is associated with the context of an article or text substantially adjacent to a given advertisement. Print advertisements embedded within pages of a print medium are typically not directed to a specific user viewing the print advertisement and therefore lack a targeted and/or interactive experience as that provided by online advertisements.

### BRIEF DESCRIPTION OF THE DRAWINGS

FIG. 1 is a functional block diagram illustrating an exemplary system including a targeted content retrieval system according to the present disclosure;

FIG. 2A illustrates an exemplary publication according to the present disclosure;

FIG. 2B is a functional block diagram of an exemplary user device;

FIG. 3 is a flow diagram illustrating steps of operating an exemplary targeted content retrieval method; and

FIG. 4 illustrates a general computer system, which may represent any of the computing devices referenced within the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. Herein, the phrase “coupled with” is defined to mean directly connected to or indirectly connected through one or more intermediate components. Such intermediate components may include both hardware and software based components.

As discussed in the background, print advertisements embedded within various print media (e.g., magazines, journals, newspapers, flyers, etc.) generally tend to reflect the context of text substantially adjacent to the advertisement itself. In other words, print advertisements typically fail to provide a user (i.e., a reader or viewer) with a targeted and/or an interactive content experience such as the experience typically presented by online content embedded within various web pages.

By way of introduction, embodiments described herein are related to various systems, devices, and methods that retrieve targeted content directed towards a specific user of a print medium and are merely exemplary in nature. There exists a need to provide targeted content to a user of a print medium in order to improve the overall experience of a print medium user. The present disclosure describes a targeted content retrieval system configured to provide targeted content received from a content server based in part on an identity of a user of a print medium, thereby improving the content experience of the user.

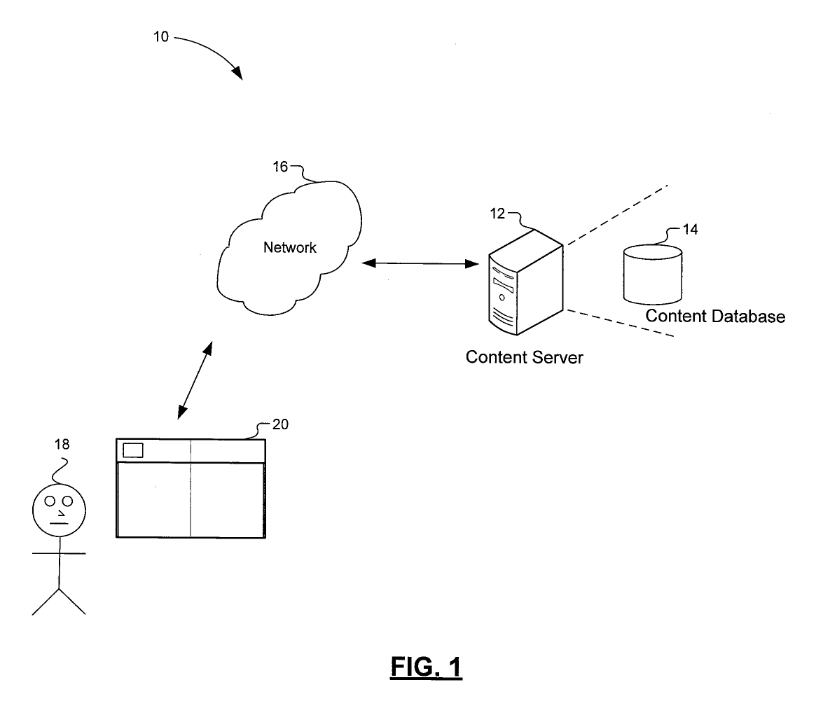

Referring to FIG. 1, an exemplary system 10 that implements the targeted content retrieval system is shown. The system 10 includes a content server 12, a content database 14, a network 16, a user 18, and a user device 20. One or more of the components may be integrated together or further sub-divided into additional discrete components. Embodiments disclosed herein may be implemented in one or more computer programs executing on one or more programmable systems comprising at least one component and at least on data storage system. Each such program may be implemented in any desired computer language to communicate with a computer system. Furthermore, variations in the arrangement and type of components may be made without departing from the spirit or scope of the claims as set for herein. Additionally, different and/or fewer components may be provided.

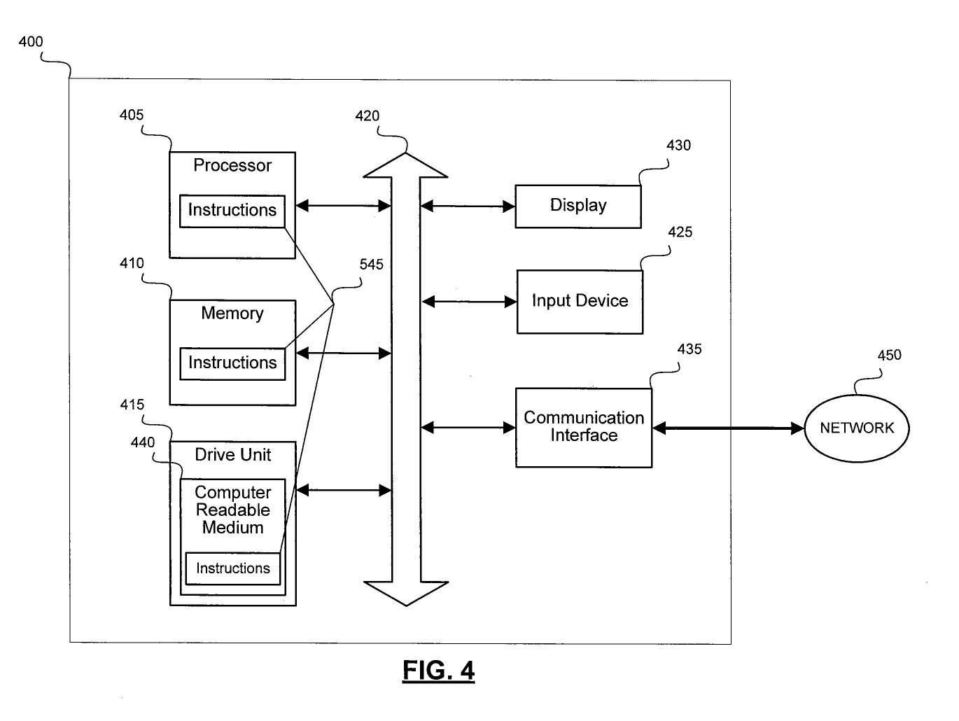

The network 16 enables the various components of the system 10 to communicate and pass data to and from one another. The network 16 may include any communication method by which information may travel between the various components of the system 10. The network 16 may include one or more of a wireless network, a wired network, a local area network (LAN), a wide area network (WAN), a direct connection such as through a Universal Serial Bus (USB) port, and may include the set of interconnected networks that make up the Internet, intranet, or other communication network. The network 16 may be the network discussed below with respect to FIG. 4.

The user device 20 communicates with the content server 12 via the network 16. The user device 20 comprises a device that the user 18, also referred to as simply the user, utilizes to connect with the network 16. In one embodiment, the network 16 is the Internet and the user device 20 connects with a website provided by the content server 12 that communicates with the network 16. There may be multiple user devices 20 representing the users that are connected with the network 16. A user may not only include an individual, but a business entity or group of people. Any user may utilize the user device 20 which may include a housing structure configured to receive and engage a print medium such as a magazine, a journal, a book, etc. having content data, also referred to simply as content. Content, as used herein, may include any content type including, but not limited to, text, static graphics, and/or images of any kind.

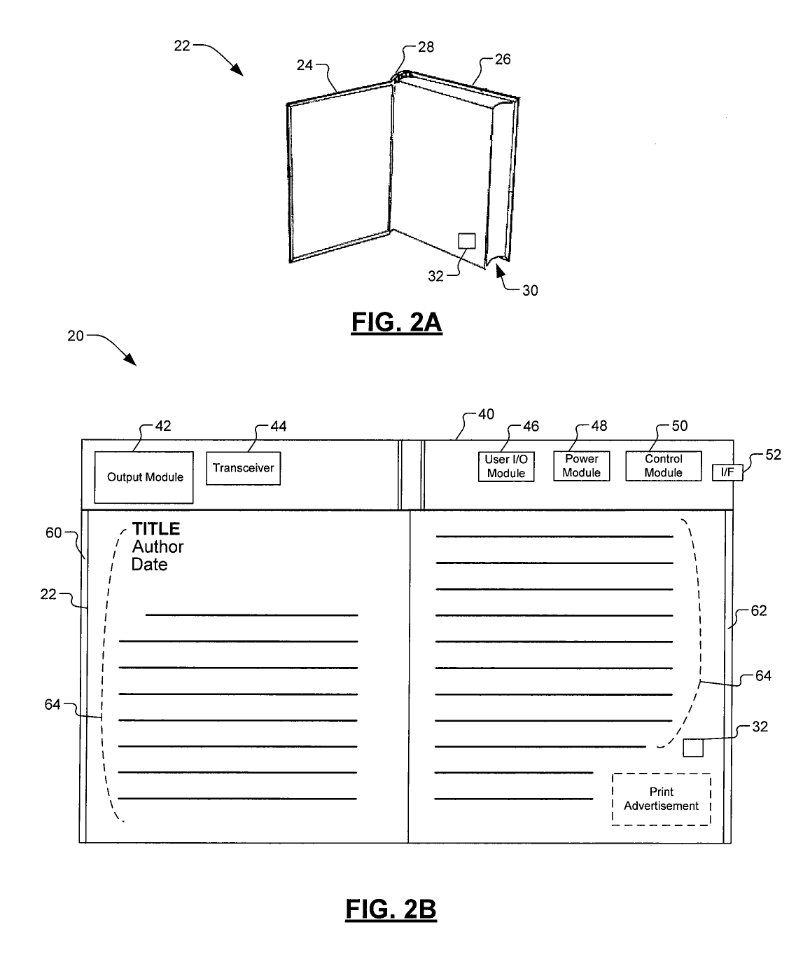

The user device 20 configured to connect with the network 16, may be the general computer system or any of the components as described with respect to FIG. 4. The user device 20 may be configured to communicate with the content server 12 through the network 16 with a web browser. The web browser provides an interface through which the user may receive content in response to a request submitted via the user device 20. There may be additional user devices 20, and additionally intermediately networks (not shown) that are established to connect the users or user devices. The structure and operation of the user device 20 will be discussed in more detail below with regards to FIG. 2B.

The content server 12 may include suitable logic, code, and/or circuitry that may enable selecting and communicating targeted content to the user device 20 via the network 16. The content server 12 may comprise a search engine (not shown). The search engine may be a content provider or web server operated over the network 16 that provides pages to users, via the user device 20. As noted above, the user device 20 may run a web browser (i.e., a browser application) or the like to display requested pages (i.e., requested URLs) received over the network 16 as described above. As discussed above, in various embodiments the search engine is a web server that provides a website that may be accessed by users (e.g., user 18) and includes the ability to conduct a search over the a network, such as the Internet. The search system offered by Yahoo! Inc. is one example of a search engine embedded in a website (www.yahoo.com). The search engine may receive a search query from a given user and provide search results to that user. The search engine may also provide other content in addition to search results.

The content server 12 may comprise a registration database (not shown) utilized to store registration data provided by various users enabling the users to activate and log into a user account via the user device 20. The registration data may include information such as each respective user's login name, password, and/or address. The registration database may also include personal information about each respective user.

The content server 12 may comprise an advertisement (ad) server. The ad server may correspond to a computer with an operating system, such as Windows® or Linux that may be suitable for hosting an advertisement server application. For example, the ad server may include an ad serving engine (not shown) for serving one or more ads for use by the user device 20. Furthermore, the ad server may include or be in communication with the content database 14. The content database 14 comprises an advertisement database. The advertisement database may include targeted advertising content, such as graphics, text, and/or audio that may be communicated to an Internet browser utilized by the user device 20.

Referring to FIGS. 2A and 2B, the operation of an exemplary embodiment of the user device 20 that implements the targeted content retrieval system is discussed in more detail. FIG. 2A illustrates an exemplary publication 22 according to the present disclosure. The publication 22 includes a front cover 24, a back cover 26, a spine 28, and a plurality of pages 30. As described in more detail below, at least one of the plurality of pages 30 includes a radio frequency identification (RFID) component 32. Although FIG. 2A depicts a book as the publication 22. The publication 22 may include, but is not limited to, periodicals, newspapers, or other print references. For the sake of simplicity and brevity, the present disclosure will discuss the operation of the user device 20 in conjunction with a magazine as the publication 22 (magazine 22).

FIG. 2B depicts an exemplary embodiment of the user device 20. The user device 20 comprises a housing structure 40 that includes an output module 42, a transceiver 44, a user input/output (I/O) module 46, a power module 48, a control module 50, and an interface module (I/F) 52. One or more of the modules and/or components may be integrated together or further sub-divided into additional discrete modules and/or components. Furthermore, variations in the arrangement, spacing, and/or type of modules and components may be made without departing from the spirit or scope of the claims as set for herein. Additionally, different and/or fewer modules and/or components may be provided.

The output module 42 may communicate with the transceiver 44 and the control module 50. The output module 42 is configured to display targeted content received from the content server 12 via the transceiver 44. The output module 42 may also produce sound waves based targeted content received as audio data from the content server 12. Targeted content may include any type of data including, but not limited to, text, static graphics, video, audio, and rich media such as Macromedia Flash. In general, the targeted content may be described by a markup language including, but not limited to, web pages, RSS feeds, audio playlists, video streams, content designed for mobile devices. In the present implementation, the output module 42 may display targeted advertising content directed at the user 18. The generation and retrieval of the targeted advertising content will be discussed in more detail below.

The output module 42 may include a video graphics array (VGA) panel, a liquid crystal display (LCD), an organic light emitting diode (OLED), a flat panel display, a solid state display, a cathode ray tube (CRT), a speaker, a projector, a printer or other now known or later developed display device for outputting targeted content for utilization by a user.

The user I/O module 46 may communicate with the control module 50 and may include any suitable mechanisms for allowing the user 18 to control the operation of the user device 20. For example, the user I/O module 46 may include any combination of buttons, keys, dials, switches, touch-pads, or visual displays. Further, the user I/O module 46 may be configured to display a list of features, options, and/or capabilities of the user device 20 that may be activated, selected, and/or adjusted by the user 18. The user device 20 may be configured to allow multiple users 18 to operate the user device 20. As such, the user I/O module 46 is configured to receive input from various users 18 indicative of their respective identity and/or preferences.

The control module 50 may communicate with the output module 42, the transceiver 44, the user I/O module 46, the power module 48, and the I/F 52. The control module 50 is configured to control and manage the operation of the user device 20. For example, the control module 50 may process input received from the user 18 via the user I/O module 46. Additionally, the control module 50 may analyze, process, and/or temporarily store targeted content prior to transmission of the targeted content to the output module 42 and/or speaker 43. The control module 50 may communicate with the power module 48 to monitor a power supply of the power module 48 and communicate the same to the user 18 via the user I/O module 46.

The I/F 52 may communicate with the control module 50 and the power module 48. The I/F 52 may establish a connection with an external source such as a computer system (not shown) to allow upgrades and/or updates to firmware resident on the control module 50 in order to provide additional functionality for the user device 20, fix defects, enhance existing operations, and/or recharge the power module 48. Although the present embodiment depicts a single I/F 52, the user device 20 may include a variable number of interface modules. The computer system may be the computer system discussed below with respect to FIG. 4

As illustrated in FIG. 2B, the housing structure 40 is configured to engage and support the magazine 22 such that the front cover 24 and the back cover 26 of the magazine 22 are removeably affixed to a first portion 60 and a second portion 62, respectively, of the housing structure 40. The first portion 60 and the second portion 62 substantially constitute an exterior “cover” relative to the front cover 24, back cover 26, and the spine 28 of the magazine 22. The housing structure 40 allows for the user to freely flip through the plurality pages 30 such that the content (e.g., content 64) printed on at least two full pages of the plurality of pages 30 are simultaneously available for viewing by the user. The housing structure 40 may comprise a material (e.g., plastic) having a rigidity that exceeds that of the magazine 22. The housing structure 40 may include various substances and/or materials to improve performance, durability, and/or reduce costs associated with manufacturing the user device 20.

As mentioned above, the magazine 22 includes a plurality of pages 30. In the present implementation, at least one page of the plurality of pages 30 includes a RFID component 32 (e.g., a RFID chip or tag) that communicates with the transceiver 44 during operation of the user device 20. The communication between the RFID component 32 and transceiver 44 will be discussed in further detail below.

RFID technology allows for the identification of unique items using radio waves. Typically, a reader (i.e., a transceiver), communicates with a transponder that stores data in a microchip. The reader has one or more antennas which function to emit radio waves (e.g., a predetermined signal) and, in response, receive signals containing the data stored on the transponder. The reader then typically proceeds to transmit the received data to another computing device to create some form of business value. Some RFID systems utilize “chipless” transponders that communicate with readers by utilizing material to reflect back a portion of radio waves beamed at the transponders from the reader antennas.

Generally, a transponder, commonly referred to as a RFID tag, contains a unique serial number and/or other distinct, identifiable data such as an account number associated with a particular customer. Transponders typically can be classified as either passive or active transponders. Active transponders possess their own transmitter and power source (e.g., a battery) and broadcast signals autonomously in order to transmit the data stored within their associated microchip. In contrast, passive transponders do not contain either a power source or a transmitter. Passive transponders require an external source (i.e., a reader) to provoke signal transmission. A passive transponder typically embeds data within reflected signals initially transmitted from a reader within range of the passive transponder. Passive transponders may be packaged in various fashions. For example, a passive transponder may mounted on a substrate to create a tag, embedded within in a card or a wall of a container, or disposed between an adhesive layer and print medium layer thereby creating a printable RFID label, or smart label. In the present implementation, the RFID component 32 comprises a passive transponder packaged as a smart label affixed to a page of the magazine 22 though other types of transponders may be implemented.

Returning to FIG. 2B, the transceiver 44 (e.g., the reader) selectively communicates with the RFID component 32, the control module 50, and the network 16. The communication between the transceiver 44, the RFID component 32, and the network 16 may be compliant with various protocols including at least one of the Institute of Electrical and Electronics Engineers (IEEE) standards 802.11, 802.11a, 802.11b, 802.11g, 802.11h, 802.11k, 802.11n, 802.11s, 802.16, 802.16a, 802.16e, 802.16-2004, 802.20 as well as other various wireless technologies such as Bluetooth, Wi-Fi, or WiMAX. Upon activation of the user device 20, the transceiver 44 establishes a connection with the network 16 in order to communicate with the content server 12. After establishing a link with the content server 12, the transceiver 44 queries or scans for the RFID component 32 positioned within range of the transceiver 44 (i.e., within close enough proximity of the transceiver 44 that enables information to be passed). In the present implementation, the RFID component 32 is a passive RFID component. As such, in response to receiving the initial communication (i.e., predetermined signal), the RFID component 32 broadcasts data to the transceiver 44.

As mentioned above, data transmitted by either a passive or active RFID component may include information indicative of a given user or customer account (i.e., identification data). In the present implementation, the data transmitted from the RFID component 32 includes a subscription identification (ID) associated with the user's subscription to a particular subscription provider that publishes the magazine 22. The subscription ID serves to indicate an identity of a subscriber (e.g., the user) similar to that of a personalized mailing address typically affixed to a cover of a conventional magazine. In the present implementation, the data transmitted from the RFID component 32 may additionally include data components indicative of the content 64 (i.e., an article) of the magazine 22. The data components may be indicative of the content 64 of magazine 22 positioned substantially adjacent to the RFID component 32. The data components may indicate the content included within specific articles or sections of a publication. For example, the data components may be representative of an author or subject matter discussed within a specific article.

The data transmitted from the RFID component 32 may further include additional information classifying a given user such as the user's age range, income range, personal preferences, etc. based on various privacy authorizations that may be granted by the user to a subscription provider of the magazine 22. It is anticipated that the additional information would exclude personal identifiable information (PII) of the user such as a social security number, credit card number(s), date of birth, etc. of the user. In the present implementation, upon receiving the subscription ID, the transceiver 44 communicates subscription ID to the content server 12 for processing.

The magazine 22 may include a plurality of secondary RFIDs components (not shown) that serve as effective “page markers” within the magazine 22. Each of the secondary RFIDs components may transmit their relevant position within the magazine 22 to the RFID component 32 (i.e., the primary RFID component) and/or the transceiver 44 for eventual transmission to the content server 12 for processing, thereby enabling the content server 12 to retrieve targeted content designated for output in relation to a particular position (i.e., a particular page) within the magazine 22.

The user device 20 may be configured to receive input from various users 18 indicative of their respective identity and/or preferences. In environments having multiple users (e.g., a household), the data transmitted from the RFID component 32 may be made secure by prompting the user, for example via the user I/O module 46, to input a n-digit numeric and/or alphanumeric password associated with the user for authenticating the identity of the user. In some embodiments, a successful authentication of a user may be required prior to the transmission of data from the RFID component 32. Additionally, in multi-user environments, the transceiver 44 may communicate other data such as a personal identification number (PIN) associated with a given user within the household along with the subscription ID discussed above to the content server 12. However, for the sake of simplicity and brevity, the present disclosure discusses operation of the targeted content retrieval system from the perspective of a single user having access to the user device 20.

The content server 12 receives the subscription ID associated with the user from the transceiver 44. The content server 12 may comprise a registration database that stores registration data provided by various users enabling the users to activate and log into a user account. For example, in the present implementation, the content server 12 may create and/or maintain records associated with respective individuals that are populated with the individual's personal data. The records maintained by the content server 12 may be substantially similar to that of the individual's on-line profile. In the present implementation, the records maintained by the context server 12 are indexed by subscription IDs. When the content server 12 receives the subscription ID from the transceiver 44, the content server can look up a particular record that corresponds to the subscription ID associated with the user. The content server 12 may then employ various content retrieval functions to extract targeted content from the content database 14 based on the retrieved record and the subscription ID for transmission to the user device 20. The user device 20 then provides the targeted content to the user 20 via the output module 42 and/or the speaker 43.

The content server 12 utilizes the preferences and interests of the user in combination with the content 64 (i.e., the text of the article) to obtain targeted content such advertisements, headlines, posts, blogs, etc. personalized to the particular user. The targeted content may be more likely to engage the user than the conventional print ads and/or other content typically incorporated in various print media, thereby increasing the effectiveness of advertising and/or other content produced for viewing by the user. Use of the disclosed targeted content retrieval system may minimize the necessity or, at a minimum, the “foot print” of conventional content previously used to generate user interest in print media or market goods and services. For example, as depicted in phantom in FIG. 2B, the magazine 22 may optionally include a conventional print advertisement.

Advertisers and content providers may also benefit from the targeted content retrieval system. Advertisers and content providers may substantially reduce their total marketing costs by leveraging content traditionally reserved for online marketing in the print environment. Additionally, by utilizing online marketing, advertisers and content providers may be able to more quickly distribute and/or modify their content in the print environment. As a result, the targeted content retrieval system may enable advertisers and content providers to significantly reduce budgets previously reserved for print marketing.

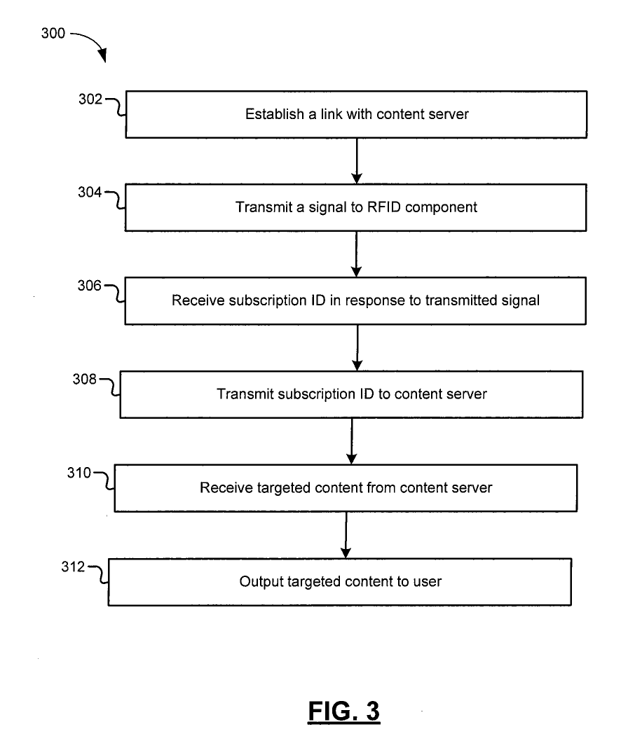

Referring to FIG. 3, an exemplary method 300 of performing a targeting content retrieval operation for a given user of a magazine 22 is shown in more detail. In block 302, the transceiver 44 establishes a link with the content server 12. In block 304, the transceiver 44 transmits a signal to the RFID component 32. In block 306, the transceiver 44 receives a subscription ID in response to the transmitted signal. In block 308, the transceiver 44 transmits the subscription ID to the content server 12. In block 310, the transceiver 44 receives targeted content from the content server 12. In block 312, the user device 20 provides the targeted content to the user.

Referring to FIG. 4, an illustrative embodiment of a general computer system, is shown and is designated 400. Any of the components shown in the computing system 400 may describe the components discussed with respect to FIGS. 1 and 2B. The computer system 400 may include a set of instructions 445 that may be executed to cause the computer system 400 to perform any one or more of the methods or computer based functions disclosed herein. The computer system 400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 400 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 445 (sequential or otherwise) that specify actions to be taken by that machine. The computer system 400 may be implemented using electronic devices that provide voice, video or data communication. Further, while a single computer system 400 may be illustrated, the term “system” shall also be taken to include any collection of systems or sub-systems that individually or jointly execute a set, or multiple sets, of instructions to perform one or more computer functions.

In FIG. 4, the computer system 400 may include a processor 405, such as, a central processing unit (CPU), a graphics processing unit (GPU), or both. The processor 405 may be a component in a variety of systems. For example, the processor 405 may be part of a standard personal computer or a workstation. The processor 405 may be one or more general processors, digital signal processors, application specific integrated circuits, field programmable gate arrays, servers, networks, digital circuits, analog circuits, combinations thereof, or other now known or later developed devices for analyzing and processing data. The processor 405 may implement a software program, such as code generated manually (i.e., programmed).

The computer system 400 may include a memory 410 that can communicate via a bus 420. For example, the registration database 110 may be stored in the memory. The memory 410 may be a main memory, a static memory, or a dynamic memory. The memory 410 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 410 may include a cache or random access memory for the processor 405. Alternatively or in addition, the memory 410 may be separate from the processor 405, such as a cache memory of a processor, the system memory, or other memory. The memory 410 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 410 may be operable to store instructions 445 executable by the processor 405. The functions, acts or tasks illustrated in the figures or described herein may be performed by the programmed processor 405 executing the instructions 445 stored in the memory 410. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 400 may further include a display 430, such as a liquid crystal display (LCD), an organic light emitting diode (OLED), a flat panel display, a solid state display, a cathode ray tube (CRT), a projector, a printer or other now known or later developed display device for outputting determined information. The display 430 may act as an interface for the user to see the functioning of the processor 405, or specifically as an interface with the software stored in the memory 410 or in the drive unit 415. In this regard, the display 430 may be utilized to display, for example, whether a business organization is a candidate for transformation. The display 430 may also be utilized to display a transformation plan. In addition, the various reports and surveys described above may be presented on the display 430.

Additionally, the computer system 400 may include an input device 430 configured to allow a user to interact with any of the components of system 400. The input device 425 may be a number pad, a keyboard, or a cursor control device, such as a mouse, or a joystick, touch screen display, remote control or any other device operative to interact with the system 400.

The computer system 400 may also include a disk or optical drive unit 415. The disk drive unit 415 may include a computer-readable medium 440 in which one or more sets of instructions 445, e.g. software, can be embedded. Further, the instructions 445 may perform one or more of the methods or logic as described herein. The instructions 445 may reside completely, or at least partially, within the memory 410 and/or within the processor 405 during execution by the computer system 400. The memory 410 and the processor 405 also may include computer-readable media as discussed above.

The present disclosure contemplates a computer-readable medium 440 that includes instructions 445 or receives and executes instructions 445 responsive to a propagated signal; so that a device connected to a network 450 may communicate voice, video, audio, images or any other data over the network 450. The instructions 445 may be implemented with hardware, software and/or firmware, or any combination thereof. Further, the instructions 445 may be transmitted or received over the network 450 via a communication interface 435. The communication interface 435 may be a part of the processor 405 or may be a separate component. The communication interface 435 may be created in software or may be a physical connection in hardware. The communication interface 435 may be configured to connect with a network 450, external media, the display 430, or any other components in system 400, or combinations thereof. The connection with the network 450 may be a physical connection, such as a wired Ethernet connection or may be established wirelessly as discussed below. Likewise, the additional connections with other components of the system 400 may be physical connections or may be established wirelessly.

The network 450 may include wired networks, wireless networks, or combinations thereof. Information related to business organizations may be provided via the network 450. The wireless network may be a cellular telephone network, an 802.11, 802.15, 802.20, or WiMax network. Further, the network 450 may be a public network, such as the Internet, a private network, such as an intranet, or combinations thereof, and may utilize a variety of networking protocols now available or later developed including, but not limited to TCP/IP based networking protocols.

The computer-readable medium 440 may be a single medium, or the computer-readable medium 440 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 440 may include a solid-state memory such as a memory card or other package that houses one or more non-volatile read-only memories. The computer-readable medium 440 also may be a random access memory or other volatile re-writable memory. Additionally, the computer-readable medium 440 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which included all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the method and system has been described with reference to certain embodiments, various changes may be made and equivalents may be substituted without departing from the scope. In addition, many modifications may be made to adapt a particular situation or material to the teachings without departing from its scope. Therefore, it is intended that the present method and system not be limited to a particular embodiment disclosed, but that the method and system include all embodiments falling within the scope of the appended claims.

What is claimed is:

1. A device for retrieving targeted content associated with a print medium, comprising:
a transceiver that receives identification data indicative of a user of the print medium, the transceiver transmitting the identification data to a content server; and
an output module that provides targeted content received from the content server to the user,
wherein the target content is based on the identification data indicative of the user.

2. The device of claim 1 wherein the identification data further comprises data indicative of the user's subscription to the print medium.

3. The device of claim 2 wherein the targeted content is associated with content printed on the print medium.

4. The device of claim 1 wherein the transceiver receives the identification data in response to a predetermined signal transmitted from the transceiver.

5. The device of claim 1 wherein the identification data is generated by a second device affixed to the print medium.

6. The device of claim 5 wherein the second device comprises a transponder.

7. The device of claim 1 wherein the targeted content comprises at least one of text, static graphics, video, audio, or rich media.

8. A method for retrieving targeted content associated with a print medium, comprising:
receiving, with a processor, identification data indicative of a user of the print medium;
transmitting the identification data to a content server; and
outputting targeted content received from the content server to the user,
wherein the target content is based on the identification data indicative of the user.

9. The method of claim 8 wherein the identification data further comprises data indicative of the user's subscription to the print medium.

10. The method of claim 9 wherein the targeted content is associated with content printed on the print medium.

11. The method of claim 8 further comprising receiving the identification data in response to a predetermined signal.

12. The method of claim 8 wherein the identification data is generated by a device affixed to the print medium.

13. The method of claim 12 wherein the device comprises a transponder.

14. The method of claim 8 wherein the targeted content comprises at least one of text, static graphics, video, audio, or rich media.

15. A computer-readable storage medium storing a computer program that includes instructions for retrieving targeted content associated with a print medium, the instructions causing a processor to:
receive identification data indicative of a user of the print medium;
transmit the identification data to a content server; and
output targeted content received from the content server to the user,
wherein the target content is based on the identification data indicative of the user.

16. The computer-readable storage medium of claim 15 wherein the identification data further comprises data indicative of the user's subscription to the print medium.

17. The computer-readable storage medium of claim 16 wherein the targeted content is associated with content printed on the print medium.

18. The computer-readable storage medium of claim 15 further comprising instruction for causing the processor to receive the identification data in response to a predetermined signal.

19. The computer-readable storage medium of claim 15 wherein the identification data is generated by a device affixed to the print medium.

20. The computer-readable storage medium of claim 15 wherein the targeted content comprises at least one of text, static graphics, video, audio, or rich media.
